(19) United States
(12) Patent Application Publication
(10) Pub. No.: US 2025/0023971 A1
(43) Pub. Date: Jan. 16, 2025

(54) ASSISTIVE TOUCH BUTTON AND ELECTRONIC DEVICE PROTECTIVE CASE

(71) Applicant: Shenzhen Yise Technology Co., Ltd, Shenzhen (CN)

(72) Inventor: Lixin Deng, Shenzhen (CN)

(21) Appl. No.: 18/904,065

(22) Filed: Oct. 1, 2024

(30) Foreign Application Priority Data
Sep. 13, 2024 (CN) 202411286547.2

(51) Int. Cl. H04M 1/02; H01H 13/04

(52) U.S. Cl. CPC H04M 1/0279; H01H 13/04; H01H 2223/04; H01H 2231/022

(57) ABSTRACT

An assistive touch button and an electronic device protective case are provided. The assistive touch button includes an insulation button block and a plurality of conductive columns; a bottom surface of the insulation button block is attached to a touch surface of a capture button; the plurality of conductive columns are arranged in a spacing manner on the insulation button block; head ends of the plurality of conductive columns extend to a top surface of the insulation button block; and tail ends of the plurality of conductive columns extend to the bottom surface of the insulation button block and abut against touch points of the touch surface. The electronic device protective case includes a case body and an assistive touch button that is mounted on the case body and corresponds to the capture button.

### TECHNICAL FIELD

The present disclosure belongs to the technical field of electronic device accessories, and in particular, to an assistive touch button and an electronic device protective case.

### BACKGROUND

With the development of science and technology, functions of electronic devices such as a mobile phone and a tablet are increasing day by day, and buttons for controlling corresponding functions are also researched and developed. For example, a capture button is mounted on a new product iPhone16 released at Apple Inc. This capture button has a capacitive touch surface and uses an advanced capacitive technology to sensitively recognize touch force and gesture changes of a user, thereby triggering different photographing functions, specifically including half press for focusing, heavy press on shutter, sliding to zoom, long press for recording, and the like. A series of complex operations are simplified and can be performed with one finger, making photographing more intuitive and efficient.

At present, the capture button is embedded in a rim of an electronic device, and there are no assistive touch members available on the market for extending the capture button. Therefore, a user needs to touch the rim of the electronic device during use, which makes the capture button lose effect in some special cases. For example, in order to protect electronic devices, most electronic devices are provided with protective cases. However, due to the lack of corresponding assistive touch members for the capture buttons on the traditional protective cases, it is impossible to use the capture buttons normally, which brings great inconvenience to the user. Therefore, it is necessary to design an assistive touch button and an electronic device protective case to solve the above problems.

### SUMMARY

### (I) Technical Problem to be Solved

The present disclosure provides an assistive touch button and an electronic device protective case, and aims to solve the problem that a capture button cannot be extended for use.

### (II) Technical Solution

In order to achieve the above objective, the present disclosure provides the following technical solutions:

An assistive touch button for use in conjunction with a capture button of an electronic device includes an insulation button block and a plurality of conductive columns. The insulation button block can be arranged on an outer side of a rim of the electronic device, and a bottom surface of the insulation button block correspondingly abuts against a touch surface of a capture button; the plurality of conductive columns are arranged in a spacing manner on the insulation button block; head ends of the plurality of conductive columns extend to a top surface of the insulation button block; and tail ends of the plurality of conductive columns extend to the bottom surface of the insulation button block and abut against a plurality of touch points of the touch surface.

Preferably, the insulation button block is made of any one of polycarbonate (PC), acrylonitrile butadiene styrene (ABS), PC+ABS, polyethylene (PE), polyamide (PA), polyethylene terephthalate (PET), polypropylene (PP), and the like. The conductive columns are made of any one of copper, copper alloy, aluminum alloy, conductive plastic, and conductive rubber.

Preferably, the plurality of conductive columns are linearly arrayed or disorderly distributed on the button block.

Preferably, the head ends of the plurality of conductive columns slightly protrude out of the top surface of the insulation button block, and the tail ends of the plurality of conductive columns slightly protrude out of the bottom surface of the insulation button block.

An electronic device protective case includes a case body and the assistive touch button. An accommodating chamber for placing an electronic device is arranged inside the case body; a notch aligned with the capture button is provided in a side wall of the accommodating chamber; the insulation button block is mounted at the notch and is located on an outer side of a rim of the electronic device; the top surface of the insulation button block is placed outside, and the bottom surface of the insulation button block faces the accommodating chamber to abut against the touch surface; the head ends of the plurality of conductive columns extend to the top surface of the insulation button block; and the tail ends of the plurality of conductive columns extend to the bottom surface of the insulation button block and synchronously abut against a plurality of touch points of the touch surface.

Preferably, a guide block is arranged on an inner wall of the notch; a guide slot is provided in a side wall of the insulation button block; the guide slot is in sliding fit with the guide block to allow the insulation button block to move relative to the notch; and the capture button is driven by pressing the insulation button block.

Preferably, the electronic device protective case further includes a diaphragm, wherein the diaphragm is arranged at the notch and is located between the insulation button block and the capture button; the diaphragm abuts against the touch surface and the bottom ends of the conductive columns; a thickness of the diaphragm is h; and a capacitance sensing range of the touch surface is d, h<d.

Preferably, the case body includes a base case and a cover plate; the accommodating chamber and the notch are arranged on the base case, and the base case is further provided with a mounting slot, communicated with the notch, in a side wall of the accommodating chamber; the diaphragm is fixed in the mounting slot and closes the notch; the diaphragm is made of a flexible material with waterproof performance; and the cover plate is mounted on the base case and closes the accommodating chamber to keep the electronic device in a closed space.

### (III) Beneficial Effects

According to the assistive touch button and the electronic device protective case provided in the present disclosure, the assistive touch button is designed with the insulation button block to correspondingly abut against the capture button. The plurality of conductive columns that are spaced apart from each other are mounted inside the insulation button block to form a plurality of independent charge transfer channels, so that charges of the touch points on the touch surface of the capture button can be transferred to the top surface of the insulation button block through the various charge transfer channels, making it convenient for touching with the fingers. Therefore, the design of the assistive touch button solves the problem that the capture button cannot be extended for use and enhances the user experience. Due to the arrangement of the assistive touch button on the electronic device protective case, a charge signal of the capture button located in the accommodating chamber can be transmitted to the outside, so that a user can still touch and use the capture button normally after the electronic device protective case is mounted on the electronic device.

### BRIEF DESCRIPTION OF THE DRAWINGS

The accompanying drawings are intended to provide a further understanding of the present disclosure and constitute a part of this specification. The accompanying drawings and embodiments of the present disclosure are used together to explain the present disclosure rather than constituting a limitation on the present disclosure. In the drawings:

FIG. 1 shows a schematic structural diagram of an assistive touch button according to the present disclosure;

FIG. 2 shows a schematic exploded diagram of FIG. 1;

FIG. 3 shows a schematic structural diagram I of other embodiments of an assistive touch button according to the present disclosure;

FIG. 4 shows a schematic structural diagram II of other embodiments of an assistive touch button according to the present disclosure;

FIG. 5 shows a schematic structural diagram of an assistive touch button and an electronic device according to the present disclosure;

FIG. 6 shows a schematic structural diagram of an electronic device protective case according to the present disclosure;

FIG. 7 shows a front view of FIG. 6;

FIG. 8 shows a sectional view A-A of FIG. 7;

FIG. 9 shows an enlarged view of the part A in FIG. 8;

FIG. 10 shows a sectional view B-B of FIG. 7;

FIG. 11 shows an enlarged view of the part B in FIG. 10;

FIG. 12 shows a schematic exploded diagram of FIG. 6;

FIG. 13 shows an enlarged view of the part C in FIG. 12;

FIG. 14 shows a partially schematic structural diagram of an electronic device protective case according to the present disclosure;

FIG. 15 shows an enlarged view of the part D in FIG. 14; and

FIG. 16 shows a diagram of a working principle of the present disclosure.

In the drawings: 1: electronic device; 10: capture button; 100: touch surface; 2: insulation button block; 20: guide slot; 3: conductive column; 4: case body; 40: accommodating chamber; 400: notch; 4000: guide block; 41: base case; 410: mounting slot; 42: cover plate; and 5: diaphragm.

### DETAILED DESCRIPTION OF THE EMBODIMENTS

The technical solutions in embodiments of the present disclosure are clearly and completely described in the following with reference to the accompanying drawings in the embodiments of the present disclosure. Apparently, the described embodiments are merely some rather than all the embodiments of the present disclosure. All other embodiments obtained by a person of ordinary skill in the art based on the embodiments of the present disclosure without making creative efforts shall fall within the protection scope of the present disclosure. It can be understood that the drawings are only for reference and illustration purposes and are not intended to limit the present disclosure. The connection relationship shown in the accompanying drawings is only for the sake of clear description and does not limit a connection method.

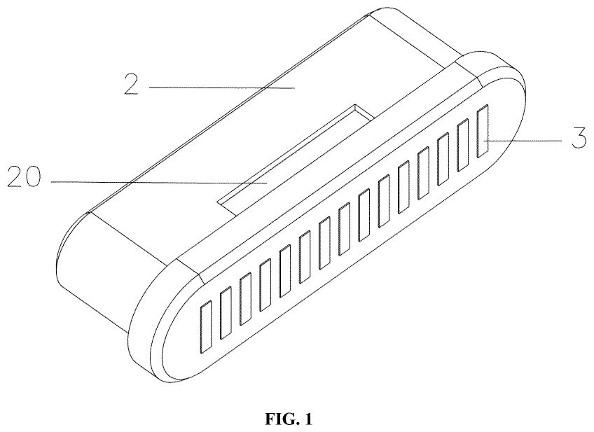

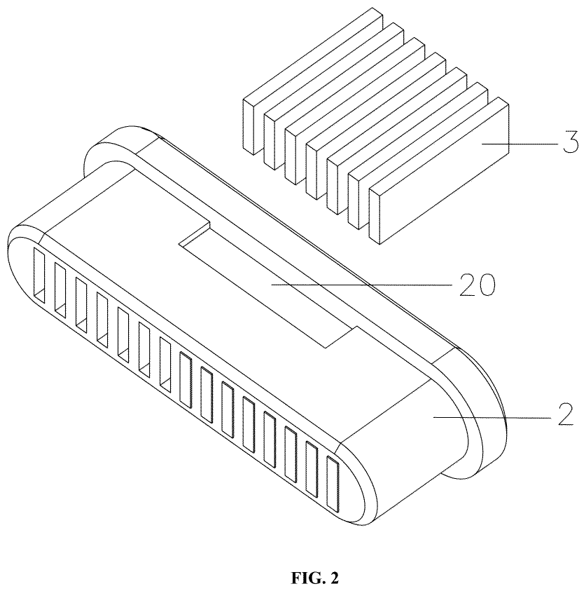

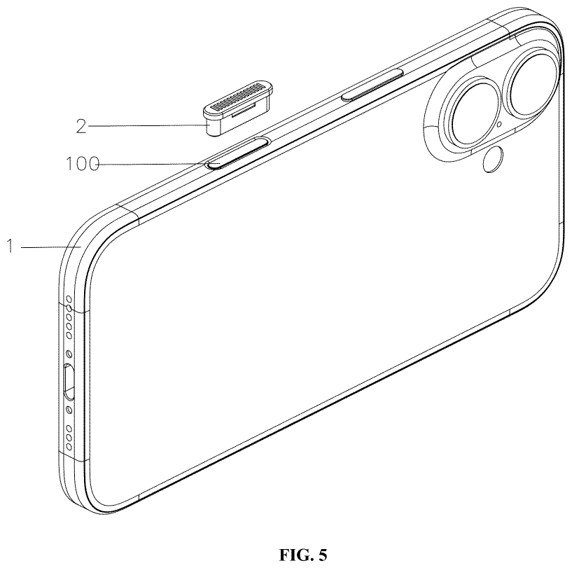

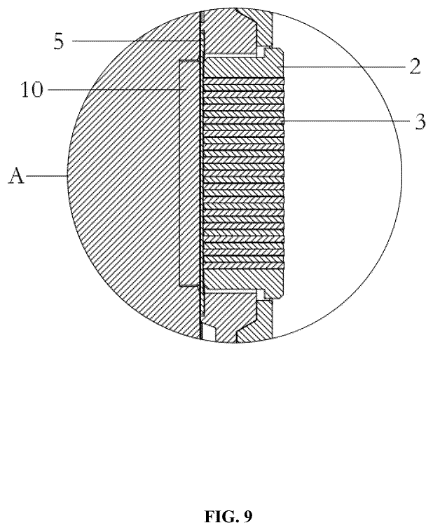

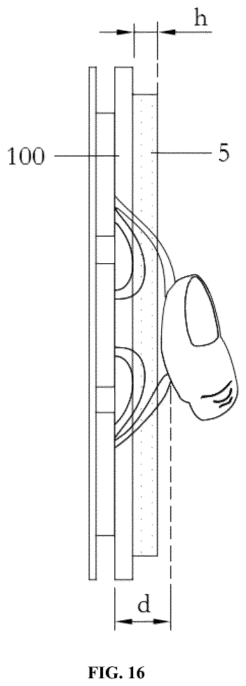

Referring to FIG. 1, FIG. 2, FIG. 5, FIG. 9, and FIG. 16, an assistive touch button for use in conjunction with a capture button 10 of an electronic device 1 includes an insulation button block 2 and a plurality of conductive columns 3. The insulation button block 2 can be arranged on an outer side of a rim of the electronic device 1, and a bottom surface of the insulation button block 2 correspondingly abuts against a touch surface 100 of a capture button 10. The plurality of conductive columns 3 are arranged in a spacing manner on the insulation button block 2. Head ends of the plurality of conductive columns 3 extend to a top surface of the insulation button block 2; and tail ends of the plurality of conductive columns 3 extend to the bottom surface of the insulation button block 2 and abut against a plurality of touch points of the touch surface 100.

Specifically, during use, the assistive touch button is mounted at the rim of the electronic device 1, and the bottom surface of the insulation button block 2 is aligned with the touch surface 100 of the capture button 10. A plurality of arrayed and charged touch points are arranged on the touch surface 100. As the tail ends of plurality of conductive columns 3 synchronously abut against the plurality of touch points of the touch surface 100, the charges at the touch points will be transmitted to the head ends of plurality of conductive columns 3 through bodies of the plurality of conductive columns 3. Namely, the plurality of conductive columns 3 can be regarded as a plurality of independent charge transfer channels, thereby forming a plurality of charged points on the top surface of the insulation button block 2.

When a user touches the corresponding charged points with the fingers, under the action of an electric field of the human body, the fingers of the user and the capture button 10 form a coupling capacitor to trigger the corresponding touch points on the touch surface 100. If the fingers slide on the top surface of the insulation button block 2, new touch points will be switched on when the fingers leave old touch points, to achieve sliding touch on the capture button 10, thereby adjust a camera for zooming.

In addition, if the assistive touch button is movably arranged on the rim of the electronic device 1, when the user presses the insulation button block 2, the capture button 10 can be driven, so that functions of the capture button 10, such as half press for focusing, heavy press on shutter, sliding to zoom, long press for recording, and the like, can be used normally.

In summary, the assistive touch button is designed with the insulation button block 2 to correspondingly abut against the capture button 10. The plurality of conductive columns 3 that are spaced apart from each other are mounted inside the insulation button block 2 to form a plurality of independent charge transfer channels, so that charges at the touch points on the touch surface 100 can be transferred to the top surface of the insulation button block 2 through the various charge transfer channels, making it convenient for touching with the fingers. Therefore, the design of the assistive touch button solves the problem that the capture button 10 cannot be extended for use and enhances the user experience.

It should be noted that regarding the mounting mode of the assistive touch button, an adhesive layer (not shown in the figure) or an adsorption layer (not shown in the figure) corresponding to the touch surface 100 can be arranged on the bottom surface of the insulation button block 2, which facilitates a user to directly bond or adsorb the insulation button block 2 to an insulation button for use. At this time, the insulation button block 2 serves as an external functional button protruding out of the rim of the electronic device 1, which is convenient for the user to touch the insulation button block and avoids the user from accidentally touching the capture button 10, thereby improving the usability. On the other hand, the assistive touch button can also be mounted on an external gamepad (not shown in the figure), so that after the electronic device 1 is mounted on the external gamepad, the user can still touch and use the capture button 10 normally while playing a game. In addition, the assistive touch button can also be mounted on an electronic device protective case for use, such as a mobile phone case and a tablet case, so that even after the electronic device 1 is mounted in the protective case, the user can still touch and use the capture button 10 normally. This solution can be found in the following text. Due to diverse practical usage scenarios and fixing modes of the assistive touch button, the present disclosure does not limit this, and the above embodiment is only for reference and understanding.

Regarding the capture button 10, which belongs to the prior art, its touch surface 100 adopts a capacitive induction technology and has a plurality of charged touch points. At present, the capture button 10 is only used on iPhone 16 released by Apple Inc, but it is not ruled out that the capture button 10 may be used in an electronic device 1 such as a tablet and a watch in the future. Furthermore, the capture button 10 is only used to control a camera function of the mobile phone, but it is not ruled out that other control programs may be set up in the future to work with the capture button. For example, the design may be as follows: sliding short videos up and down by touching the capture button 10, to controlling music track switching, or the like. Therefore, this assistive touch button is only used to extend the capture button 10 for use. There are no restrictions on the usage scenarios and control functions of the capture button 10.

Referring to FIG. 1 to FIG. 4 and FIG. 9, the insulation button block 2 is made of any one of PC, ABS, PC+ABS, PE, PA, PET, and PP. This type of material has good insulation performance and can effectively prevent the charges of the capture button 10 from being transferred to the insulation button block 2 and interfering with the conductive columns 3. In addition, there are many materials with insulation performance, which are not listed one by one in the present disclosure, but other insulation materials can be considered as conventional substitutions in the present disclosure.

Referring to FIG. 1 to FIG. 4 and FIG. 9, the conductive columns 3 are made of any one of copper, copper alloy, aluminum alloy, conductive plastic, or conductive rubber. This type of material has good conductivity and can smoothly transfer the charges of the capture button 10 to form a plurality of stable charge points on the top surface of the insulation button block 2 for a user to touch. In addition, there are various materials with conductive properties, which are not listed one by one in the present disclosure, but other conductive materials can be considered as conventional substitutions in the present disclosure.

Referring to FIG. 1 to FIG. 4, there are various arrangement modes for the plurality of conductive columns 3, which are not limited in the present disclosure. For case of understanding, the following embodiments are listed here:

### Embodiment I

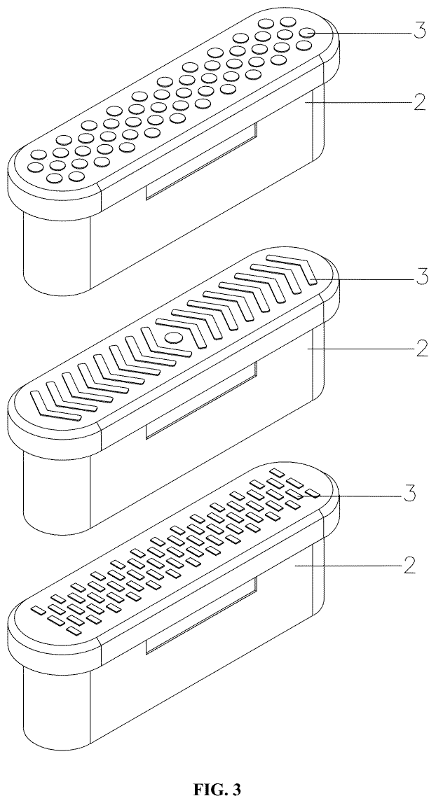

The plurality of conductive columns 3 are linearly arrayed on the button block to orderly correspond to the plurality of touch points on the touch surface 100. This design can make the entire touch button more attractive and can have an effect of prompting a user of a sliding direction, thereby enhancing the user experience. A specific style is as shown in FIG. 1 and FIG. 3.

### Embodiment II

The plurality of conductive columns 3 are disorderly distributed on the button block to correspond to the plurality of touch points of the touch surface 100 in a disorderly manner. This design allows the plurality of conductive columns 3 to be interspersed at will, making it convenient to form various irregular patterns at the top surface of the insulation button block 2, which increases the fun. There are diverse specific pattern styles, and corresponding illustrations are not provided here.

Referring to FIG. 1, FIG. 3, and FIG. 9, the head ends of the plurality of conductive columns 3 slightly protrude out of the top surface of the insulation button block 2. On one hand, due to this design, when sliding on the top surface of the insulation button block 2, a user can smoothly touch the head ends of the plurality of conductive columns 3 with the fingers to complete charge receiving/transferring; and on the other hand, the tactile sensation of sliding can be improved, and the user experience is enhanced.

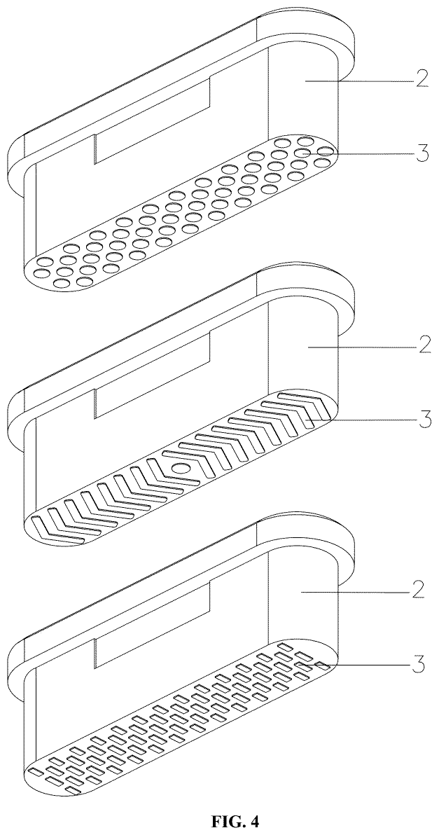

Referring to FIG. 2, FIG. 4, and FIG. 9, the tail ends of the plurality of conductive columns 3 slightly protrude out of the bottom surface of the insulation button block 2. Due to this design, it can ensure that the tail ends of the plurality of conductive columns 3 are smoothly in contact with and abut against the plurality of touch points of the touch surface 100, thereby avoiding the occurrence of touch interruption and improving the stability of transferring of charges.

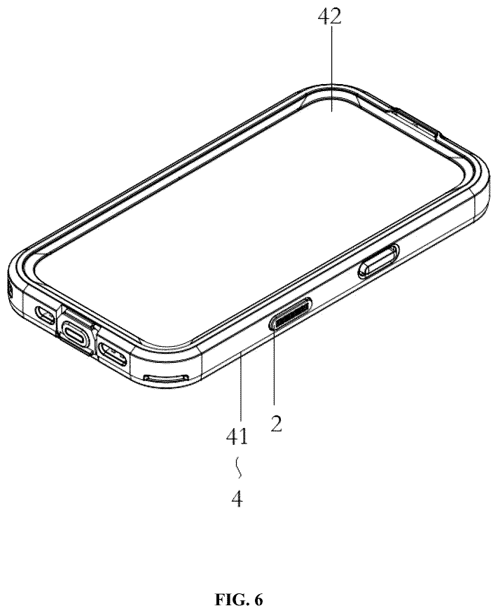

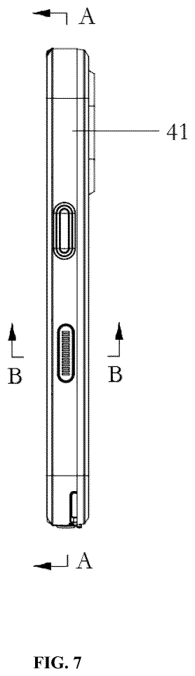

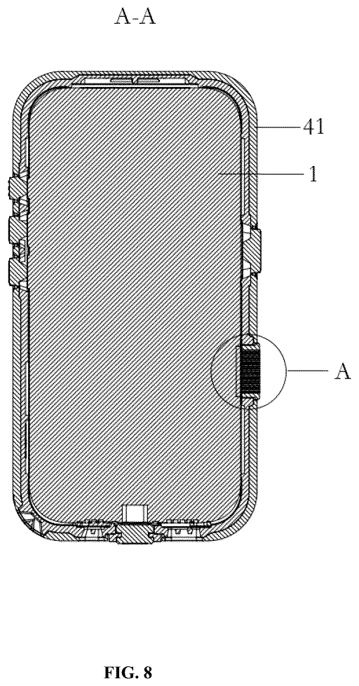

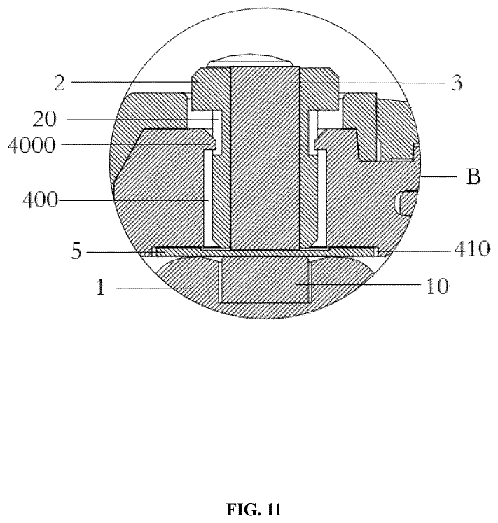

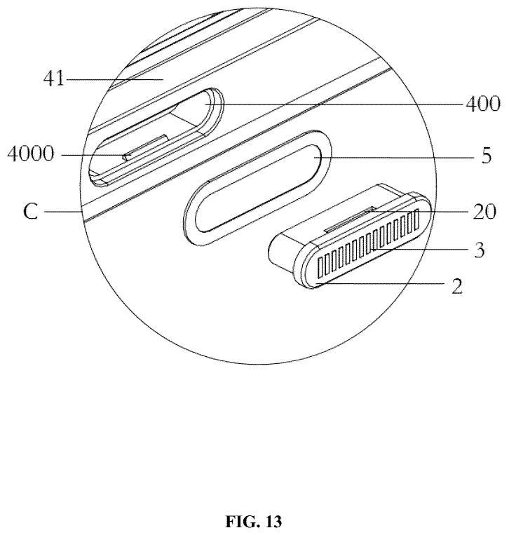

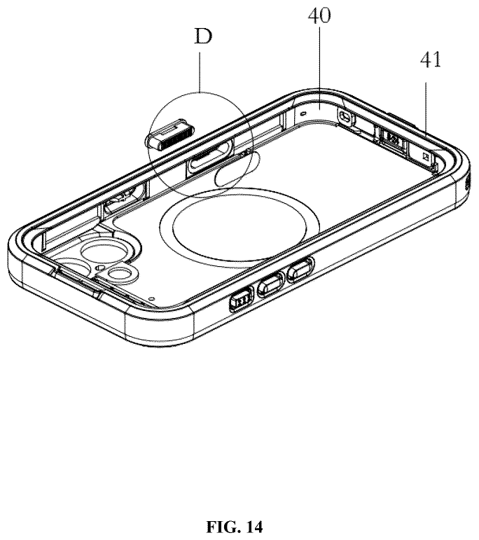

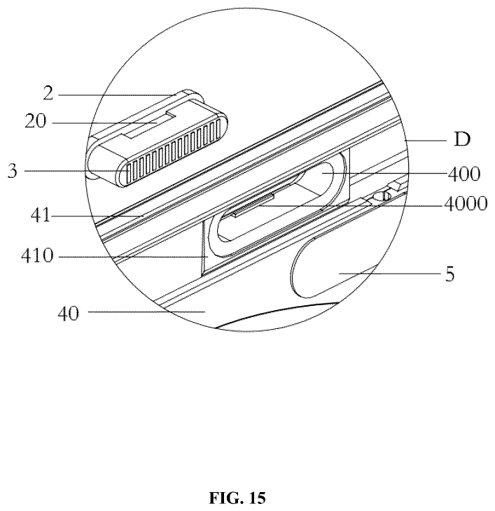

Referring to FIG. 6 to FIG. 15, an electronic device protective case includes a case body 4 and an assistive touch button. An accommodating chamber 40 for placing an electronic device 1 is arranged inside the case body 4; a notch 400 aligned with a capture button 10 is provided in a side wall of the accommodating chamber 40; an insulation button block 2 is mounted at the notch 400 and is located on an outer side of a rim of the electronic device 1; a top surface of the insulation button block 2 is placed outside, and the bottom surface of the insulation button block 2 faces the accommodating chamber 40 to abut against a touch surface 100; head ends of a plurality of conductive columns 3 extend to the top surface of the insulation button block 2; and the tail ends of the plurality of conductive columns 3 extend to the bottom surface of the insulation button block 2 and synchronously abut against a plurality of touch points of the touch surface 100.

Specifically, during use, the electronic device 1 is mounted in the accommodating chamber 40 and drive the capture button 10 to be aligned with the notch 400, so that the bottom surface of the insulation button block 2 and the tail ends of the plurality of conductive columns 3 can properly abut against the touch surface 100 of the capture button 10. At this time, the charges at the plurality of touch points on the touch surface 100 can be smoothly transferred to the various conductive columns 3, without interfering with each other, and ultimately form charged points on the top surface of the insulation button block 2, so that a user can normally slide and touch, on the outer side of the case body 4, the capture button 10 located inside the case body 4.

It should be noted that regarding the mounting mode for the assistive touch button, in addition to mounting the assistive touch button on the electronic device protective case for use, the assistive touch button can also be mounted on an external device such as an external gamepad for use. The specific situation has been mentioned in the previous text, and will not be described in detail here.

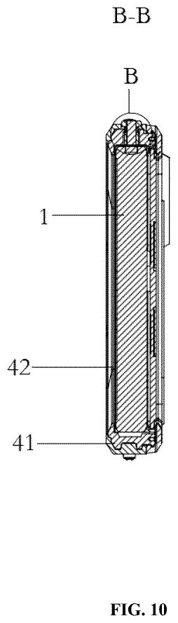

Referring to FIG. 10 to FIG. 15, in fact, if only the sliding to zoom function of the capture button 10 needs to be used, the insulation button block 2 can be fixedly mounted at the notch 400, which can enable the plurality of conductive columns 3 to more stably abut against the touch surface 100 of the capture button 10, thereby achieving sliding touch. However, if the functions of the capture button 10, such as sliding to zoom, half press for focusing, heavy press on shutter, and long press for recording, are used simultaneously, it is necessary to ensure that the insulation button block 2 has a range of motion when mounted at the notch 400, to facilitate the driving on the capture button 10. Therefore, in the present disclosure, a guide block 4000 is arranged on an inner wall of the notch 400, and a guide slot 20 is provided in a side wall of the insulation button block 2. The guide slot 20 is in sliding fit with the guide block 4000 to allow the insulation button block 2 to move relative to the notch 400; and the capture button 10 can be driven by pressing the insulation button block 2.

Specifically, when the electronic device 1 is mounted in the accommodating chamber 40, the bottom surface of the insulation button block 2 and the tail ends of the plurality of conductive columns 3 abut against the touch surface 100 of the capture button 10. At this time, the guide block 4000 is located on the topmost side of the guide slot 20, so that the insulation button block 2 is limited and fixed at the notch 400. Because the guide block 4000 is in sliding fit with the guide slot 20, the assistive touch button can move along the guide slot 20. Therefore, when a user presses the insulation button block 2, the capture button 10 can be correspondingly driven, thereby achieving the functions such as half press for focusing, heavy press on shutter, and long press for recording.

Referring to FIG. 10 to FIG. 16, the present disclosure further includes a diaphragm 5. The diaphragm 5 is arranged at the notch 400 and is located between the insulation button block 2 and the capture button 10. The diaphragm 5 abuts against the touch surface 100 and the bottom ends of the conductive columns 3. A thickness of the diaphragm 5 is h, and a capacitance sensing range of the touch surface 100 is d, h<d.

Specifically, the design of the diaphragm 5 can prevent the insulation button block 2 and the conductive columns 3 from directly resisting against and scratching the touch surface 100, to provide a protection effect. However, considering that the diaphragm 5 itself does not have conductivity, to avoid the diaphragm 5 from hindering the transfer of the charges to the conductive columns 3, it is necessary to ensure that the thickness h of the diaphragm 5 is less than the capacitance sensing range d of the touch surface 100. A specific working principle can be found in FIG. 16. After the diaphragm 5 is attached to the touch surface 100, the charges can still be transferred to the fingers through the diaphragm 5. If the fingers are replaced with the conductive columns 3 here, the charges can be transferred to the conductive columns 3.

Therefore, in a case of h<d, the capture button 10 can still be used normally.

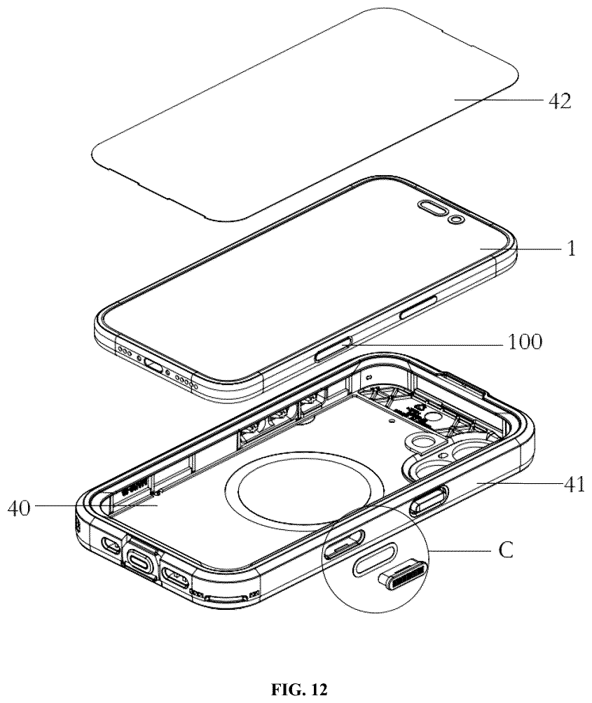

Referring to FIG. 12 to FIG. 15, the case body 4 includes a base case 41 and a cover plate 42; the accommodating chamber 40 and the notch 400 are arranged on the base case 41, and the base case 41 is further provided with a mounting slot 410, communicated with the notch 400, in a side wall of the accommodating chamber 40; the diaphragm 5 is fixed in the mounting slot 410 and closes the notch 400; the diaphragm 5 is made of a flexible material with waterproof performance; and the cover plate 42 is mounted on the base case 41 and closes the accommodating chamber 40 to keep the electronic device 1 in a closed space.

Specifically, in this structural design, the case body 4 has a waterproof function, so that a user can view a screen of the electronic device 1 normally in water, and use the capture button 10 to control a camera function of the electronic device 1, making it convenient for the user to take photos or videos in water.

Further, there are various kinds of flexible materials with waterproof performance, such as thermoplastic polyurethane (TPU), polyvinyl chloride (PVC), and other flexible plastic, which are not limited in the present disclosure.

It should be noted that the sealing design of the base shell 41 and the cover plate 42 is clearly described in a waterproof case of the existing electronic device 1, which belongs to the prior art. Therefore, this will not be further elaborated in the present disclosure. The diaphragm 5 can be adhered and fixed in the mounting slot 410 by glue. Due to the flexibility of the diaphragm 5, when a user presses the insulation button block 2, the diaphragm 5 may undergo adaptive deformation without leaving the mounting slot 410, ensuring that the insulation button block 2 can drive the capture button 10 normally.

It should be also noted that although the embodiments of the present disclosure have been shown and described, it can be understood by those of ordinary skill in the art that various changes, modifications, substitutions, and variations can be made to these embodiments without departing from the principle and spirit of the present disclosure.

What is claimed is:

1. An assistive touch button for use in conjunction with a capture button of an electronic device, comprising:
an insulation button block, wherein the insulation button block is arranged on an outer side of a rim of the electronic device, and a bottom surface of the insulation button block correspondingly abuts against a touch surface of a capture button; and
a plurality of conductive columns, wherein the plurality of conductive columns are arranged in a spacing manner on the insulation button block; head ends of the plurality of conductive columns extend to a top surface of the insulation button block; and tail ends of the plurality of conductive columns extend to the bottom surface of the insulation button block and abut against a plurality of touch points of the touch surface.

2. The assistive touch button according to claim 1, wherein the insulation button block is made of any one of polycarbonate (PC), acrylonitrile butadiene styrene (ABS), PC+ABS, polyethylene (PE), polyamide (PA), polyethylene terephthalate (PET), polypropylene (PP), and the like; and the conductive columns are made of any one of copper, copper alloy, aluminum alloy, conductive plastic, and conductive rubber.

3. The assistive touch button according to claim 1, wherein the plurality of conductive columns are linearly arrayed on the button block to correspond in an orderly manner to the plurality of touch points on the touch surface.

4. The assistive touch button according to claim 1, wherein the plurality of conductive columns are disorderly distributed on the button block to correspond in a disorderly manner to the plurality of touch points on the touch surface.

5. The assistive touch button according to claim 1, wherein the head ends of the plurality of conductive columns slightly protrude out of the top surface of the insulation button block to be smoothly in contact with the fingers and enhance tactile sensation.

6. The assistive touch button according to claim 1, wherein the tail ends of the plurality of conductive columns slightly protrude out of the bottom surface of the insulation button block to smoothly abut against the plurality of touch points of the touch surface.

7. An electronic device protective case, comprising a case body and the assistive touch button according to claim 1, wherein
an accommodating chamber for placing an electronic device is arranged inside the case body; a notch aligned with the capture button is provided in a side wall of the accommodating chamber;
the insulation button block is mounted at the notch and is located on an outer side of a rim of the electronic device; the top surface of the insulation button block is placed outside, and the bottom surface of the insulation button block faces the accommodating chamber to abut against the touch surface; the head ends of the plurality of conductive columns extend to the top surface of the insulation button block; and the tail ends of the plurality of conductive columns extend to the bottom surface of the insulation button block and synchronously abut against a plurality of touch points of the touch surface.

8. The electronic device protective case according to claim 7, wherein a guide block is arranged on an inner wall of the notch; a guide slot is provided in a side wall of the insulation button block; the guide slot is in sliding fit with the guide block to allow the insulation button block to move relative to the notch; and the capture button is driven by pressing the insulation button block.

9. The electronic device protective case according to claim 8, further comprising a diaphragm, wherein the diaphragm is arranged at the notch and is located between the insulation button block and the capture button; the diaphragm abuts against the touch surface and the bottom ends of the conductive columns; a thickness of the diaphragm is h; and a capacitance sensing range of the touch surface is d, h<d.

10. The electronic device protective case according to claim 9, wherein the case body comprises a base case and a cover plate; the accommodating chamber and the notch are arranged on the base case, and the base case is further provided with a mounting slot, communicated with the notch, in a side wall of the accommodating chamber; the diaphragm is fixed in the mounting slot and closes the notch; the diaphragm is made of a flexible material with waterproof performance; and the cover plate is mounted on the base case and closes the accommodating chamber to keep the electronic device in a closed space.
